(19) United States
(12) Patent Application Publication
(10) Pub. No.: US 2022/0324268 A1
(43) Pub. Date: Oct. 13, 2022

(54) PNEUMATIC TIRE

(71) Applicant: The Yokohama Rubber Co., LTD., Tokyo (JP)

(72) Inventor: Masatoshi SHIMIZU, Kanagawa (JP)

(21) Appl. No.: 17/597,976

(22) PCT Filed: Jul. 15, 2020
(86) PCT No.: PCT/JP2020/027531

§ 371 Date: Jan. 31, 2022

(30) Foreign Application Priority Data
Aug. 5, 2019 (JP) 2019-144028

(51) Int. Cl. B60C 13/02

(52) U.S. Cl. CPC B60C 13/02; B60C 2013/005

(57) ABSTRACT

A pneumatic tire includes a serration region in a predetermined region of a sidewall portion. The serration region is formed by arranging a plurality of ridges, the plurality of ridges protruding from a base surface in parallel to each other and being periodically arranged. A length of one cycle of the plurality of ridges along the base surface is 0.5 mm or more and 0.7 mm or less. The pneumatic tire includes a plane portion surrounded by the serration region.

### TECHNICAL FIELD

The present technology relates to a pneumatic tire.

### BACKGROUND ART

An indicator of a brand or the like may be attached to a tire side portion of a pneumatic tire. In order to improve the visibility and appearance of the indicator of the brand or the like, there is a demand for tires with high self-cleaning performance that can easily wash away the deposits on the tire side portions by rain or cleaning the vehicle. If an organic cleaning agent is used, cracks may occur due to deterioration of a side rubber, and it is necessary to improve the cleaning performance with only water. From the perspective of taking into consideration of the influence on the environment due to the outflow of the cleaning agent, a tire having high cleaning performance only with water without using a cleaning agent is useful.

Japan Patent No. 3422715 discloses a pneumatic tire in which the visibility of a decorative portion provided on a sidewall portion is enhanced. Japan Patent No. 4371625 discloses a pneumatic tire in which a ridge is provided on a sidewall portion to suppress deterioration of appearance due to cracks occurring on a rubber surface.

Japan Patent Nos. 3422715 and 4371625 do not take both the visibility performance and the cleaning performance into consideration, and there is room for improvement in both the visibility performance and the cleaning performance.

### SUMMARY

The present technology provides a pneumatic tire capable of enhancing both visibility performance and cleaning performance.

A pneumatic tire according to an aspect of the present technology is a pneumatic tire including a tread portion, a sidewall portion, and a bead portion, a serration region being provided in a predetermined region of the sidewall portion, the serration region being formed by arranging a plurality of ridges, the plurality of ridges protruding from a base surface in parallel to each other and periodically, a length Lb of one cycle of the plurality of ridges along the base surface being 0.5 mm or more and 0.7 mm or less, and the pneumatic tire including a plane portion surrounded by the serration region.

Preferably, when a length of the one cycle of the plurality of ridges along the base surface is defined as the length Lb, and a length along a contour of the ridge per the one cycle in a cross-sectional view along a direction orthogonal to an extension direction of the plurality of ridges is defined as a length Lr, a ratio Lr/Lb of the length Lr to the length Lb is 1.2 or more and 2.0 or less.

Preferably, a ratio PH/RH of a height PH of the plane portion from the base surface to a height RH of each of the plurality of ridges from the base surface is 0.6 or more and 1.4 or less.

Preferably, an angle θp between a side wall of the plane portion and the base surface is 45° or more and 75° or less, in a cross-sectional view along a tire radial direction of a connection portion between each of the plurality of ridges and the plane portion.

Preferably, in a cross-sectional view along a tire radial direction of a connection portion between each of the plurality of ridges and the plane portion, in a portion where a contour line of a top surface of the plane portion and a contour line of a side wall of the plane portion intersect each other, the contour lines are connected by an arc that is single, and a ratio RP/PH of a radius of curvature RP of the arc to a height PH of the plane portion from the base surface is 0.5 or more and less than 1.0.

Preferably, an opening width La between the ridges that are adjacent is 0.15 mm or more and 0.35 mm or less, in a cross-sectional view along a direction orthogonal to an extension direction of the ridge.

Preferably, a ratio La/Lb of the opening width La to the length Lb is 0.3 or more and 0.6 or less.

Preferably, the base surface includes a flat portion having no unevenness, the flat portion is a straight line in a cross-sectional view along a direction orthogonal to an extension direction of the ridge, and a length of the straight line is 0.15 mm or more.

Preferably, a ratio RH/Lb, to the length Lb, of a height RH from the base surface to a maximum projection position of the ridge is 0.11 or more and 0.3 or less.

Preferably, in a tire meridian cross-section, a ratio LH/SH, to a tire cross-sectional height SH, of a length LH in a tire radial direction of a range in the tire radial direction of the serration region is 0.2 or more and 0.4 or less.

Preferably, in a tire meridian cross-section, when a height along a tire radial direction from a measurement point of a rim diameter of a rim on which the pneumatic tire is mounted to a position on inner side of the serration region in the tire radial direction is defined as AH, a ratio AH/SH of the height AH to a tire cross-sectional height SH is 0.3 or more and 0.5 or less.

Preferably, an angle θr between a flat portion of the base surface having no unevenness and a wall surface of the ridge is 60° or more and 85° or less.

Preferably, an angle θc in an extension direction of the ridge with respect to a tire radial direction is within a range of ±20° with respect to the tire radial direction.

Preferably, an arithmetic mean roughness Ra of rubber on a surface of the ridge is 0.1 μm or more and 5 μm or less.

Preferably, the pneumatic tire further includes a first protrusion portion extending in a tire circumferential direction at a position on an outer side of the serration region in a tire radial direction, and a second protrusion portion extending in the tire circumferential direction at a position on an inner side of the serration region in the tire radial direction.

Preferably, a protrusion height of the first protrusion portion and the second protrusion portion from a tire profile smoothly changes along the tire circumferential direction, and the protrusion height changes in a range of 40% or more and 100% or less with respect to a maximum value of the protrusion height.

Preferably, the protrusion height of the first protrusion portion and the second protrusion portion from the tire profile is 0.7 mm or less.

According to the pneumatic tire according to the present technology, both the visibility performance and the cleaning performance can be improved.

### BRIEF DESCRIPTION OF DRAWINGS

FIG. 1 is a meridian cross-sectional diagram illustrating a main portion of a pneumatic tire according to an embodiment.

FIG. 2 is a side diagram of a pneumatic tire according to an embodiment of the present technology.

FIG. 3 is a diagram illustrating in an enlarged view of a portion of a serration region in FIG. 2.

FIG. 4 is a diagram illustrating in an enlarged view of a portion of the serration region in FIG. 2.

FIG. 5 is a diagram illustrating an example of a connection portion between a ridge of a serration region and a plane portion.

FIG. 6 is a cross-sectional diagram illustrating an example of a ridge provided in a serration region in FIG. 2.

FIG. 7 is a cross-sectional diagram illustrating an example of a ridge provided in a serration region in FIG. 2.

FIG. 8 is a diagram illustrating the hydrophilic property of the surface of a member forming the contour of the ridge.

FIG. 9 is a diagram illustrating the hydrophilic property of the surface of a member forming the contour of a ridge.

FIG. 10 is a diagram illustrating an enlarged view of a portion of FIG. 7.

FIG. 11 is a cross-sectional diagram illustrating an example of the structure of a connection portion between a ridge and a plane portion.

FIG. 12 is a cross-sectional diagram illustrating another example of the structure of the connection portion between the ridge and the plane portion.

FIG. 13 is a diagram illustrating an example of the arrangement of ridges in a serration region.

FIG. 14 is a diagram illustrating an example of the arrangement of ridges in a serration region.

FIG. 15 is a diagram illustrating an example of the shape of a ridge.

FIG. 16 is a diagram illustrating an example of the shape of a ridge.

### DETAILED DESCRIPTION

Embodiments of the present technology are described in detail below with reference to the drawings. In the embodiments described below, identical or substantially similar components to those of other embodiments have identical reference signs, and descriptions of those components are either simplified or omitted. The present technology is not limited by the embodiments. Constituents of the embodiments include elements that are substantially identical or that can be substituted and easily conceived by one skilled in the art. Furthermore, the plurality of modified examples described in the embodiments can be combined as desired within the scope apparent to one skilled in the art.

In the following description, “tire width direction” refers to the direction parallel to the rotation axis (not illustrated) of a pneumatic tire 1. “Outer side in the tire width direction” refers to the side away from a tire equatorial plane (tire equator line) in the tire width direction. “Tire circumferential direction” refers to the circumferential direction with the rotation axis as the center axis. “Tire radial direction” refers to the direction orthogonal to the rotation axis. “Inner side in the tire radial direction” refers to the side toward the rotation axis in the tire radial direction. “Outer side in the tire radial direction” refers to the side away from the rotation axis in the tire radial direction. “Tire equatorial plane” is the plane orthogonal to the rotation axis that passes through the center of the tire width of the pneumatic tire 1. “Tire width” is the width in the tire width direction between components located on the outer side in the tire width direction, or in other words, the distance between the components that are the most distant from the tire equatorial plane in the tire width direction. Furthermore, “tire equator line” refers to the line in the circumferential direction of the pneumatic tire 1 that lies on the tire equatorial plane.

### Pneumatic Tire

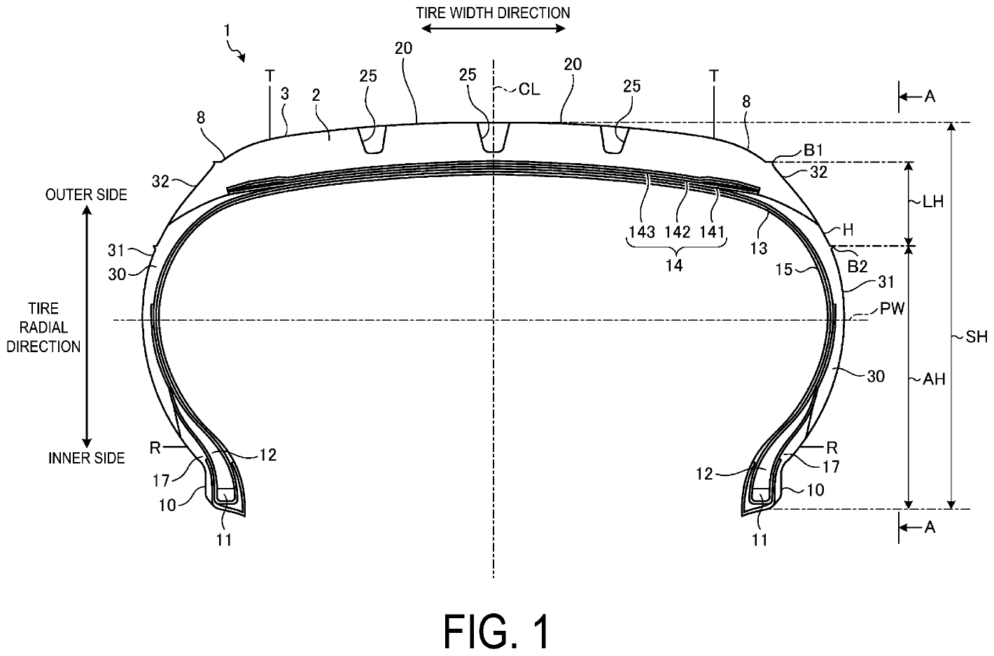

FIG. 1 is a meridian cross-sectional diagram illustrating a main portion of a pneumatic tire according to an embodiment. In the pneumatic tire 1 illustrated in FIG. 1, a tread portion 2 is arranged at the outermost portion in the tire radial direction when viewed in a meridian cross-section. The surface of the tread portion 2, that is, the portion that comes into contact with the road surface during traveling of a vehicle (not illustrated) mounted with the pneumatic tire 1, includes a tread surface 3. A plurality of circumferential main grooves 25 extending in the tire circumferential direction are formed in the tread surface 3. A plurality of land portions 20 are defined in the tread surface 3 by the circumferential main grooves 25. Grooves other than the circumferential main grooves 25 may be formed in the tread surface 3. For example, lug grooves (not illustrated) extending in the tire width direction, narrow grooves (not illustrated) different from the circumferential main grooves 25, and the like may be formed in the tread surface 3.

Shoulder portions 8 are located at both ends of the tread portion 2 in the tire width direction. Sidewall portions 30 are arranged on an inner side of the shoulder portion 8 in the tire radial direction. The sidewall portions 30 are arranged at two locations on both sides of the pneumatic tire 1 in the tire width direction. The surface of the sidewall portion 30 is formed as a tire side portion 31. The tire side portions 31 are located on both sides in the tire width direction. The two tire side portions 31 each face an opposite side of a side in the tire width direction where the tire equatorial plane CL is located.

In this case, the tire side portion 31 refers to a surface that uniformly continues in a range on the outer side in the tire width direction from a ground contact edge T of the tread portion 2 and on the outer side in the tire radial direction from a rim check line R. Further, the ground contact edge T refers to both outermost edges in the tire width direction of a region in which the tread surface 3 of the tread portion 2 of the pneumatic tire 1 contacts the road surface with the pneumatic tire 1 assembled on a regular rim, inflated to the regular internal pressure, and loaded with 70% of the regular load. The ground contact edge T is continuous in the tire circumferential direction. Moreover, the rim check line R refers to a line used to confirm whether the tire has been mounted on the rim correctly and, typically, on a front side surface of bead portions 10, the rim check line R is closer to the outer side in the tire radial direction than a rim flange (not illustrated) and is an annular convex line continuing in the tire circumferential direction along a portion approximate to the rim flange.

The non-ground contact region of the connection portion between the profile of the tread portion 2 and the profile of the sidewall portion 30 is called a buttress portion. A buttress portion 32 constitutes a side wall surface on an outer side of the shoulder portion 8 in the tire width direction.

Note that “regular rim” refers to an “applicable rim” defined by the Japan Automobile Tyre Manufacturers Association (JATMA), a “Design Rim” defined by The Tire and Rim Association, Inc. (TRA), or a “Measuring Rim” defined by The European Tyre and Rim Technical Organisation (ETRTO). Additionally, “regular internal pressure” refers to a “maximum air pressure” defined by JATMA, the maximum value in “TIRE LOAD LIMITS AT VARIOUS COLD INFLATION PRESSURES” defined by TRA, or “INFLATION PRESSURES” defined by ETRTO. Additionally, “regular load” refers to a “maximum load capacity” defined by JATMA, a maximum value in “TIRE LOAD LIMITS AT VARIOUS COLD INFLATION PRESSURES” defined by TRA, or “LOAD CAPACITY” defined by ETRTO.

The bead portion 10 is located on an inner side of each of the sidewall portions 30 in the tire radial direction located on both sides in the tire width direction. The bead portions 10 are arranged at two locations on both sides of the tire equatorial plane CL, similarly to the sidewall portions 30. Each bead portion 10 is provided with a bead core 11, and a bead filler 12 is provided on an outer side in the tire radial direction of the bead core 11.

A plurality of belt layers 14 are provided on an inner side of the tread portion 2 in the tire radial direction. The belt layers 14 include a plurality of cross belts 141, 142 and a belt cover 143 and form a multilayer structure. Of these, the cross belts 141 and 142 are formed by performing a rolling process on a plurality of coating rubber-covered belt cords made of steel or an organic fiber material. The cross belts 141 and 142 have a belt angle of 20° or more and 55° or less in absolute value. Furthermore, the belt cords of the cross belts 141, 142 have different set inclination angles of the fiber direction of the belt cords with respect to the tire circumferential direction, and the belts are layered so that the fiber directions of the belt cords intersect each other, i.e., a crossply structure. The belt cover 143 is formed by performing a rolling process on coating rubber-covered steel or a plurality of cords made of an organic fiber material. The belt cover 143 has a belt angle of 0° or more and 10° or less in absolute value. The belt cover 143 is disposed in a layered manner an outer side of the cross belts 141, 142 in the tire radial direction.

A carcass 13 containing the cords of radial plies is continuously provided on an inner side in the tire radial direction of the belt layer 14 and on a side of the sidewall portion 30 close to the tire equatorial plane CL. The carcass 13 has a single layer structure made of one carcass ply or a multilayer structure made of a plurality of layered carcass plies. The carcass 13 spans the bead cores 11 disposed on both sides in the tire width direction in a toroidal shape, forming the backbone of the tire. Specifically, the carcass 13 is disposed to span from one bead portion 10 to the other bead portion 10 among the bead portions 10 located on both sides in the tire width direction and turns back toward the outer side in the tire width direction along the bead cores 11 at the bead portions 10 so as to wrap around the bead cores 11 and the bead fillers 12. The carcass ply of the carcass 13 is formed by performing a rolling process on a plurality of coating rubber-covered carcass cords made of steel or an organic fiber material, such as aramid, nylon, polyester, rayon, and the like. The carcass ply has a carcass angle of 80° or more and 95° or less in absolute value, the carcass angle being an inclination angle of the fiber direction of the carcass cords with respect to the tire circumferential direction.

At the bead portion 10, a rim cushion rubber 17 is disposed on the inner side in the tire radial direction and the outer side in the tire width direction of the bead core 11 and a turned back portion of the carcass 13, the rim cushion rubber 17 forming a contact surface of the bead portion 10 against the rim flange. Additionally, an innerliner 15 is formed along the carcass 13 on an inner side of the carcass 13 or on an inner portion side of the carcass 13 in the pneumatic tire 1.

### Serration Region

In FIG. 1, the pneumatic tire 1 includes a protrusion portion B1 and a protrusion portion B2 on the buttress portion 32. A serration region H is defined between the protrusion portion B1 and the protrusion portion B2. The serration region H is located on an outer side of a maximum width position PW of the pneumatic tire 1 in the tire radial direction. The serration region H is formed by arranging a plurality of ridges as described later, and the plurality of ridges are arranged parallel to each other and periodically. A ratio LH/SH of a length LH in the tire radial direction in the range in the tire radial direction of the serration region H to a tire cross-sectional height SH is 0.2 or more and 0.4 or less.

Further, when a height along the tire radial direction from a measurement point of the rim diameter of the rim (not illustrated) on which the pneumatic tire 1 is mounted, to a position on an inner side of the serration region H in the tire radial direction is defined as AH, a ratio AH/SH of the height AH to the tire cross-sectional height SH is 0.3 or more and 0.5 or less.

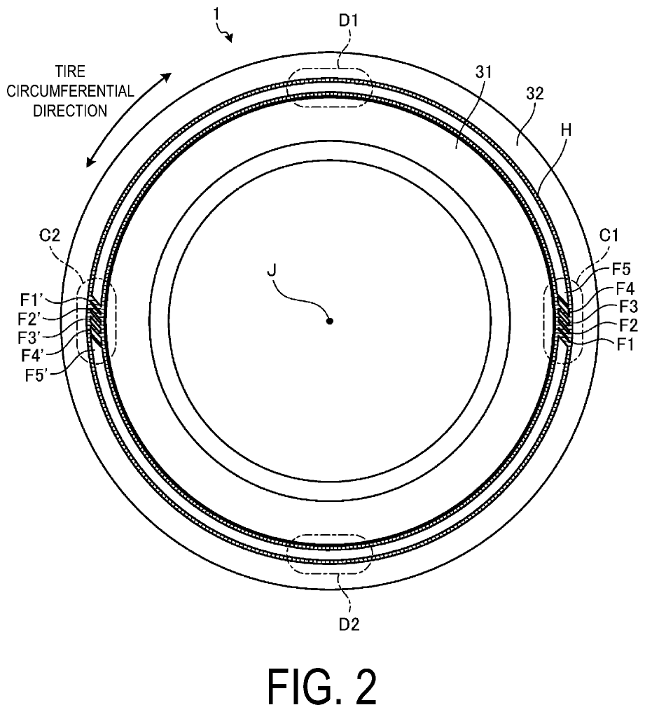

FIG. 2 is a side diagram of the pneumatic tire 1 according to an embodiment of the present technology. FIG. 2 is a side diagram of the pneumatic tire 1 including the view taken along an arrow A-A of FIG. 1. In FIG. 2, the serration region H is provided on the tire side portion 31.

The tire side portion 31 may be provided with a decorative portion for the purpose of improving the appearance of the pneumatic tire 1 and displaying various kinds of information. The decorative portion may include various kinds of information such as a brand name, a logo mark, or a product name for identifying the pneumatic tire 1 or for illustrating those to users.

In FIG. 2, ten plane portions F1 to F5 and F1′ to F5′ are provided in the serration region H of the tire side portion 31 of this example. In this example, the plane portion F1 and the plane portion F1′ have an identical shape, the plane portion F2 and the plane portion F2′ have an identical shape, the plane portion F3 and the plane portion F3′ have an identical shape, and the plane portion F4 and the plane portion F4′ have an identical shape, and the plane portion F5 and the plane portion F5′ have an identical shape. Among these plane portions, the plane portions F1 and F1′ have the shortest maximum length in the tire circumferential direction, and the plane portions F5 and F5′ have the longest maximum length in the tire circumferential direction.

The ten plane portions F1 to F5 and F1′ to F5′ illustrated in FIG. 2 are examples, and more plane portions may be provided. Each plane portion may be provided over the entire circumference in the tire circumferential direction, or may be provided on a portion of the entire circumference in the tire circumferential direction.

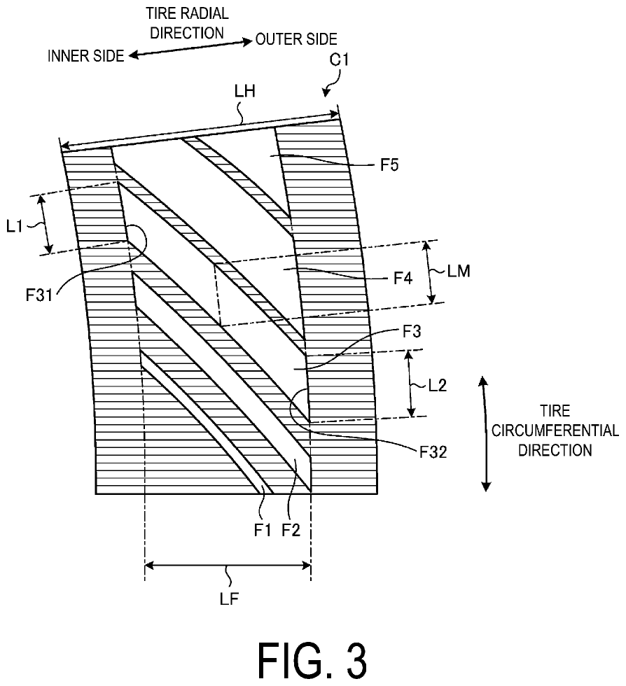

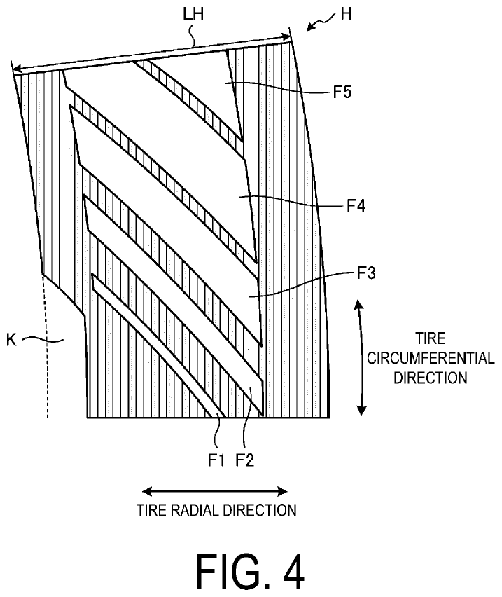

FIGS. 3 and 4 are diagrams illustrating in an enlarged view of a portion C1 which is a portion of the serration region H in FIG. 2. As illustrated in FIG. 3, the plane portions F1, F2, F3, F4, and F5 are provided in the serration region H. The plane portions F1, F2, F3, F4, and F5 are flat portions having no unevenness surrounded by the serration region H. The plane portions F1, F2, F3, F4, and F5 are arranged in the tire circumferential direction and overlap each other when viewed in the tire circumferential direction. Further, the plane portions F1, F2, and F3 are arranged side by side in the tire radial direction, and partially overlap each other when viewed in the tire radial direction. The plane portions F2, F3, and F4 are arranged side by side in the tire radial direction, and partially overlap each other when viewed in the tire radial direction. The plane portions F3, F4, and F5 are arranged side by side in the tire radial direction, and partially overlap each other when viewed in the tire radial direction. As described above, the plane portions provided in the serration region H may partially overlap each other when viewed in the tire circumferential direction or the tire radial direction.

Focusing on the boundaries between the plane portions F1, F2, F3, F4, and F5 and the serration region H, it can be considered that the plane portions F1, F2, F3, F4, and F5 are adjacent to the serration region H. By providing the plane portion surrounded by the serration region H, the visibility of the serration region is improved due to the contrast between the serration region H and the plane portion. In addition, the plane portions F1 to F5 may be surfaces having an identical height to the tire profile.

Here, attention is directed to the plane portion F3. Assuming that the entire circumference of the tire is 100%, a length L1 in the tire circumferential direction of a side F31 on an inner side of the plane portion F3 in the tire radial direction is preferably 1% or more and 99% or less of the tire circumferential length at the position of the side F31. A length L2 in the tire circumferential direction of a side F32 on an outer side of the plane portion F3 in the tire radial direction is preferably 1% or more and 99% or less of the tire circumferential length at the position of the side F32. A length LM in the tire circumferential direction at a position half a maximum length LF in the tire radial direction of the plane portion F3 is preferably 1% or more and 99% or less of the tire circumferential length at that position. The same applies to the other plane portions F1, F2, F4, and F5. The maximum length LF of each of the plane portions F1, F2, F3, F4, and F5 in the tire radial direction is preferably 50% or more and 90% or less of the length LH.

As illustrated in FIG. 4, a notch portion K may be formed in the serration region H. As illustrated in FIG. 4, due to the presence of the notch portion K, the length LH of the serration region H in the tire radial direction does not have to be uniform in the tire circumferential direction.

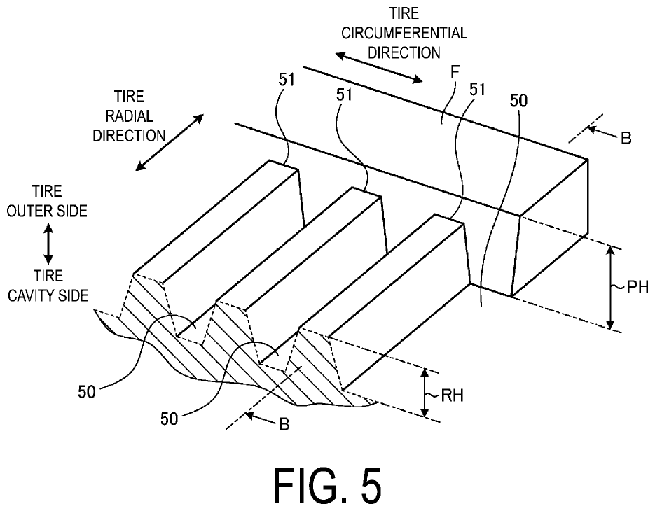

FIG. 5 is a diagram illustrating an example of a connection portion between a ridge of the serration region H and a plane portion. FIG. 5 illustrates an enlarged view of the connection portion between the ridge and the plane portion (hereinafter may be referred to simply as a connection portion). In this example, the cross-sectional shape of each ridge 51 in the direction orthogonal to the extension direction is trapezoidal. By arranging a plurality of ridges having a trapezoidal cross-sectional shape, the surface area of the tire side portion can be increased, and the wettability and cleaning property can be improved.

A ratio PH/RH of a height PH from a base surface 50 of the plane portion F to a height RH from the base surface 50 of each of the plurality of ridges 51 is preferably 0.6 or more and 1.4 or less. The height PH of the plane portion F may be lower than the height RH of the ridge 51. By setting the height PH of the plane portion F to be lower than the height RH of the ridge 51 or not to greatly exceed the height RH even if it is higher than the height RH of the ridge 51, the cleaning property can be ensured without water being blocked at the plane portion. If the ratio PH/RH exceeds 1.4, water is blocked at the plane portion of the connection portion, and the cleaning performance cannot be improved, which is not preferable.

### Cross-Sectional Shape of Ridge

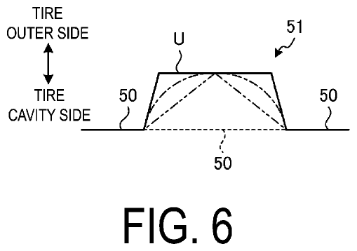

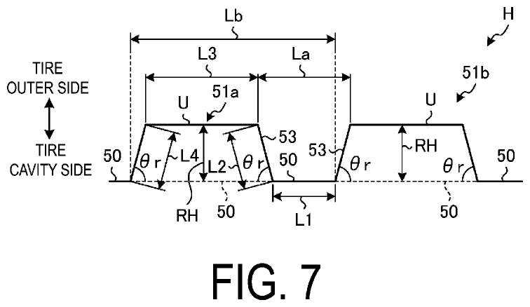

FIGS. 6 and 7 are cross-sectional diagrams illustrating an example of a ridge provided in the serration region H. FIGS. 6 and 7 are cross-sectional diagrams taken along a direction orthogonal to the extension direction of the ridge. FIG. 6 is a cross-sectional diagram illustrating an example of one ridge 51. FIG. 7 is a cross-sectional diagram illustrating an example of adjacent ridges 51a and 51b.

In FIG. 6, the ridge 51 protrudes toward the outer side in the tire radial direction from the base surface 50. The ridge 51 has a mountain ridge-like convex shape and extends along the tire side portion 31. The ridge 51 is substantially trapezoidal in a cross-sectional view along a direction orthogonal to the extension direction. The substantially trapezoidal shape is a shape including a flat portion having no unevenness on the upper bottom, that is, a top surface U. The ridge 51 may be an arc as indicated by the dot-dash line, or may be a triangle as indicated by the two-dot chain line. When the shape of the ridge 51 is trapezoidal in a cross-sectional view, the surface area of the ridge can be increased as compared with other shapes (arc, triangle) even if the height is identical, and the hydrophilic property can be improved. Further, even if it is trapezoidal, since the lower bottom coincides with the base surface 50, water can easily enter the base surface 50 as compared with the case where the upper bottom coincides with the base surface 50, and the hydrophilic property and the cleaning property can be improved.

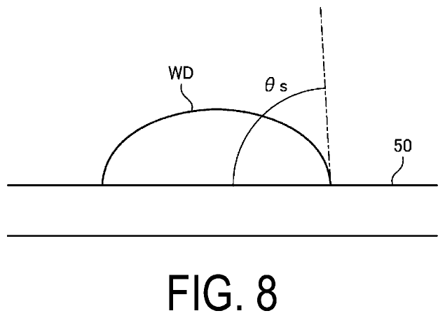

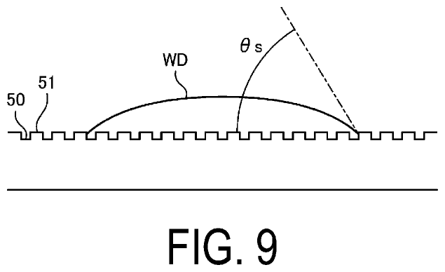

Further, the surface of the member forming the contour of each of the ridges 51a and 51b described above has a hydrophilic property. By providing the ridges 51a and 51b on the member having the hydrophilic property, the hydrophilic property can be enhanced. FIGS. 8 and 9 are diagrams for explaining the hydrophilic property of the surface of the member forming the contour of the ridges 51a and 51b. As illustrated in FIG. 8, the flat base surface 50 without the ridge 51 is considered. At this time, it is assumed that a contact angle θs between a water droplet WD and the base surface 50 is less than 90°, and the base surface 50 has a hydrophilic property. As illustrated in FIG. 9, since the plurality of ridges 51 protruding from the base surface 50 are provided, the contact angle θs is smaller than that in the case of FIG. 8. Therefore, the surface of the member including the base surface 50 and the ridge 51 exhibits higher hydrophilic property than the flat base surface 50.

An arithmetic mean roughness Ra of the rubber on the surfaces of the ridges 51a and 51b is preferably 0.1 μm or more and 5 μm or less. The hydrophilic property can be increased by optimizing the surface roughness. The hydrophilic property is increased by increasing the surface roughness. However, if the roughness is too large, it becomes difficult for water to enter the recess portion of the roughness, and the hydrophilic property deteriorates. The arithmetic mean roughness Ra is more preferably 0.2 μm or more and 4 μm or less. The arithmetic mean roughness Ra is measured according to JIS (Japanese Industrial Standard)-B0601.

Returning to FIG. 7, the base surface 50 is a surface recessed from a profile line 52 toward a tire cavity side. The profile line is a contour line that smoothly connects the buttress portion 32 and the bead portion 10 in the tire meridian cross-section. A profile line is composed of a single arc or a plurality of arcs. A profile line is defined excluding partial unevenness. The buttress portion 32 is a non-ground contact region of the connection portion between the profile of the tread portion 2 and the profile of the sidewall portion, and constitutes a side wall surface on the outer side of the shoulder portion 8 in the tire width direction.

As illustrated in FIG. 7, the plurality of ridges 51a and 51b protrude from the base surface 50 toward an outer side of the tire. Here, a length along the contour of the ridge per one cycle in the cross-sectional view along the direction orthogonal to the extension direction of the plurality of ridges 51a and 51b is defined as Lr. The length Lr is the periphery length along the contour of the ridge 51 per one cycle of the plurality of ridges 51 in the cross-sectional view along the direction orthogonal to the extension direction of the plurality of ridges 51. That is, when focusing on the ridge 51a, the length Lr is the total length of a length L1 of the base surface, a length L2 of a wall surface 53, a length L3 of the top surface U, and a length L4 of the wall surface 53.

Further, a length of one cycle of the plurality of ridges 51a and 51b along the base surface 50 is defined as Lb. That is, the length Lb is the length of one pitch of the plurality of ridges 51a and 51b. A ratio Lr/Lb of the length Lr to the length Lb is preferably 1.2 or more and 2.0 or less. By increasing the surface area of the ridge, the hydrophilic property of the serration region H can be improved, and the self-cleaning effect of the sidewall portion 30 when sludge is attached can be enhanced. If the ratio Lr/Lb exceeds 2.0 when the cross-sectional shape of the ridge is complex or fine, water will not enter the base surface 50 and the hydrophilic property is lowered, which is not preferable. If the ratio Lr/Lb is less than 1.2, the effect of improving the cleaning performance by the improvement in the hydrophilic property is small, which is not preferable. The ratio Lr/Lb is more preferably 1.3 or more and 1.5 or less.

The length Lb is preferably 0.5 mm or more and 0.7 mm or less. If the length Lb is less than 0.5 mm, it becomes difficult for water to enter the base surface 50 and the hydrophilic property is lowered, which is not preferable. If the length Lb exceeds 0.7 mm, the cleaning performance deteriorates, which is not preferable. If the length Lb is smaller than 0.5 mm, it becomes difficult for water to enter the base surface 50, and the hydrophilic property and the cleaning performance are deteriorated, which is not preferable.

Further, the length Lb is more preferably 0.52 mm or more, and further preferably 0.54 mm or more. When the length Lb is 0.52 mm or more, favorable results are obtained in terms of the visibility performance and the cleaning performance. Further, when the length Lb is 0.54 mm or more, more favorable results are obtained in terms of the visibility performance and the cleaning performance.

In FIG. 7, in a cross-sectional view along a direction orthogonal to the extension direction of the ridges, an opening width La between adjacent ridges is preferably 0.15 mm or more and 0.35 mm or less. When the value of the opening width is within this range, favorable results are obtained in terms of the visibility performance and the cleaning performance. The opening width La is the distance between boundary points, the boundary point between the wall surface 53 of the ridge and the top surface of the ridge in a cross-sectional view along a direction orthogonal to the extension direction of the ridge.

Here, the top surface U of the ridges 51a and 51b and the wall surface 53 of the ridges 51a and 51b may be connected by a curved line, and the boundary between the top surface U and the wall surface 53 may not be clear. In that case, the opening width La is measured on the basis of the intersection point between a line extended from a linear portion of the top surface U of the ridge 51 and a line extended from a linear portion of the wall surface 53 of the ridge 51.

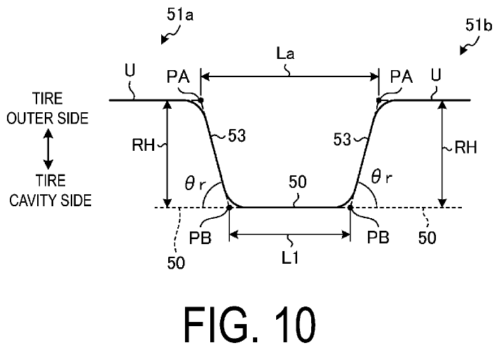

FIG. 10 is a diagram illustrating in an enlarged view of a portion of FIG. 7. FIG. 10 is a diagram illustrating in an enlarged view of the space between the ridge 51a and the ridge 51b in FIG. 7. FIG. 10 is a diagram illustrating an example in which the top surface U of the ridges 51a and 51b and the wall surface 53 of the ridges 51a and 51b are connected by a curved line in a cross-sectional view in a direction orthogonal to the extension direction of the ridges 51a and 51b. As illustrated in FIG. 10, when the boundary between the top surface U of the ridges 51a and 51b and the wall surface 53 is not clear, the opening width La is measured on the basis of an intersection point PA between the line extended from the linear portion of the top surface U of the ridge 51 and a line extended from the linear portion of the wall surface 53 of the ridge 51.

Returning to FIG. 7, a ratio La/Lb of the opening width La to the length Lb is preferably 0.3 or more and 0.6 or less. When the value of the ratio La/Lb is within this range, favorable results are obtained in terms of the visibility performance and the cleaning performance.

The height RH from the base surface 50 to the maximum projection position of the ridges 51a and 51b is preferably 0.08 mm or more and 0.15 mm or less. As described above, since the length Lb is preferably 0.5 mm or more and 0.7 mm or less, a ratio RH/Lb of the height RH to the length Lb is preferably 0.11 or more and 0.3 or less. When the value of the ratio RH/Lb is within this range, favorable results are obtained in terms of the visibility performance and the cleaning performance.

As illustrated in FIG. 7, the base surface 50 includes a flat portion having no unevenness. The flat portion of the base surface 50 is a straight line in a cross-sectional view along a direction orthogonal to the extension direction of the ridges 51a and 51b. Even if dirt adheres to the base surface 50, since there is a flat portion, water can enter the base surface 50 and the dirt can be washed away together with the water. The length of the straight line of the base surface 50 in the cross-sectional view is preferably 0.15 mm or more. If the length L1 of the straight line of the base surface 50 is 0.15 mm or more, favorable results are obtained in terms of the visibility performance and the cleaning performance.

Here, the base surface 50 and the wall surfaces 53 of the ridges 51a and 51b may be connected by a curved line, and the boundary between the base surface 50 and the wall surface 53 may not be clear. In that case, as illustrated in FIG. 10, the length L1 is measured on the basis of an intersection point PB between the line extended from the straight line of the base surface 50 and the line extended from the linear portion of the wall surface 53 of the ridge 51.

Returning to FIG. 7, an angle θr between the flat portion of the base surface 50 and the wall surfaces 53 of the ridges 51a and 51b is preferably 60° or more and 85° or less. When the angle θr is within this range, favorable results are obtained in terms of the visibility performance and the cleaning performance. The hydrophilic property can be enhanced by setting the angle θr appropriately. If the angle θr is larger than 85°, it becomes difficult for water to enter the base surface 50, and the hydrophilic property deteriorates. If the angle θr is smaller than 60°, the surface area does not increase and a sufficient hydrophilic property cannot be improved. The angle θr is more preferably 70° or more and 80° or less.

Here, the base surface 50 and the wall surfaces of the ridges 51a and 51b may be connected by a curved line, and the boundary between the base surface 50 and the wall surface 53 may not be clear. In that case, as illustrated in FIG. 10, the angle θr is measured on the basis of the intersection point PB between the line extended from the straight line of the base surface 50 and the line extended from the linear portion of the wall surface 53 of the ridge 51. The angle θr may be determined by measuring the angle between the line extended from the straight line of the base surface 50 and the line extended from the linear portion of the wall surface 53 of the ridge 51 and subtracting the angle from 180°.

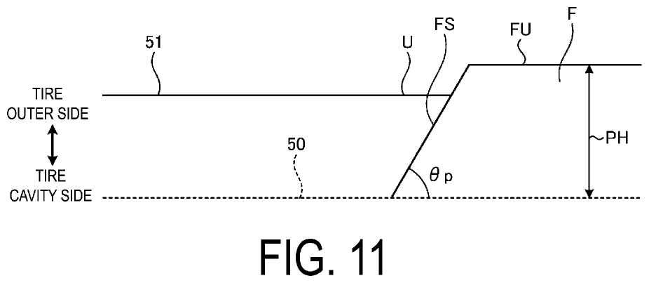

FIG. 11 is a cross-sectional diagram illustrating an example of the structure of the connection portion between the ridge and the plane portion. FIG. 11 is a diagram illustrating a cross-section of the connection portion along the tire radial direction. FIG. 11 is a diagram illustrating a cross-section along a portion B-B in FIG. 5. In FIG. 11, the top surface U of the ridge 51 includes a flat portion having no unevenness in a cross-sectional view of the connection portion between the ridge 51 and the plane portion F along the tire radial direction. A top surface FU of the plane portion F includes a flat portion having no unevenness. An angle θp between a side wall FS of the plane portion F and the base surface 50 is preferably 45° or more and 75° or less. The same applies to the other ridges 51. By providing the side wall FS of the plane portion F with an inclination, it becomes difficult to block the spread of water, and the cleaning property can be improved. If the angle θp is smaller than 45°, the ridge contour length Lr of the connection portion cannot be sufficiently ensured, and the wettability of the connection portion deteriorates, which is not preferable. If the angle θp is larger than 75°, a sufficient blocking suppression effect is not obtained, which is not preferable.

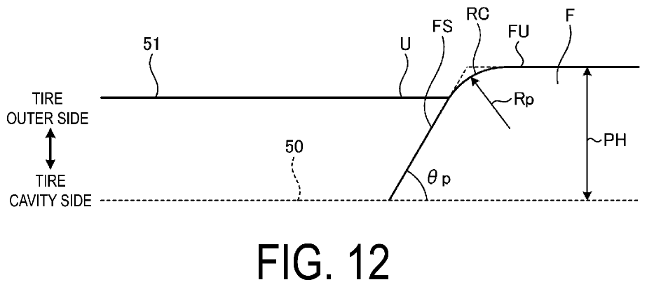

FIG. 12 is a cross-sectional diagram illustrating another example of the structure of the connection portion between the ridge and the plane portion. FIG. 12 is a diagram illustrating a cross-section of the connection portion along the tire radial direction. In FIG. 12, in a portion where the contour line of the top surface FU of the plane portion F and the contour line of the side wall FS of the plane portion F intersect in a cross-sectional view of the connection portion between the ridge 51 and the plane portion F along the tire radial direction, these contour lines are connected by a single arc RC, and a ratio RP/PH of a radius of curvature RP of the arc RC to the height PH of the plane portion F from the base surface 50 is preferably 0.5 or more and less than 1.0. The same applies to the other ridges 51.

By R-chamfering the corner between the top surface FU and the side wall FS of the plane portion F, it becomes difficult to block the spread of water, and the cleaning performance can be improved. If the ratio RP/PH is larger than 0.5, the length Lr of the connection portion cannot be sufficiently ensured, and the wettability of the connection portion deteriorates, which is not preferable. If the ratio RP/PH is less than 0.1, a sufficient blocking suppressing effect is not obtained, which is not preferable.

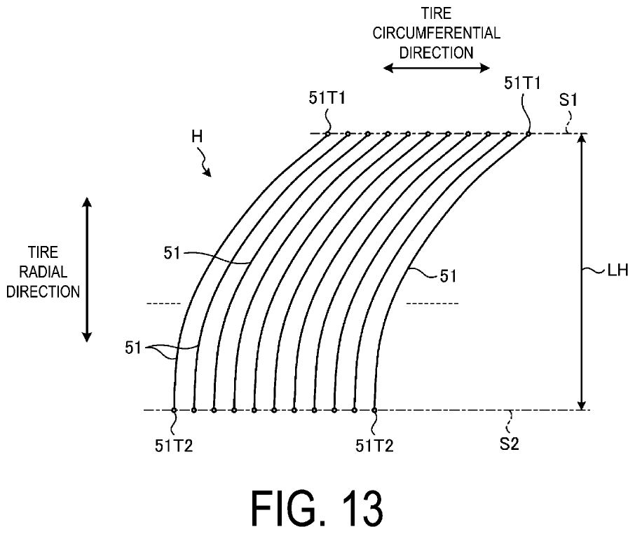

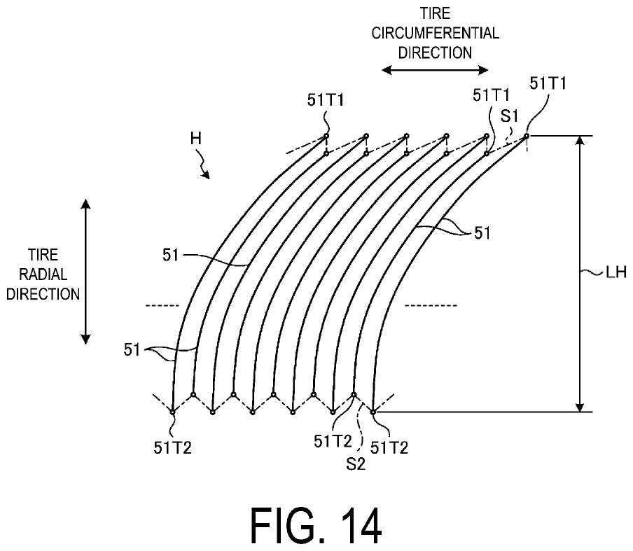

FIGS. 13 and 14 are diagrams illustrating an example of arrangement of ridges in the serration region H. In FIGS. 13 and 14, each of the plurality of ridges provided in the serration region H is indicated by a line. It is assumed that the ridges that are not drawn are provided in the tire circumferential direction in the same manner as the ridges that are clearly drawn in FIGS. 13 and 14.

As illustrated in FIG. 13, the plurality of ridges 51 are provided in the serration region H. Each of the ridges 51 is arranged in parallel with the adjacent ridges 51. Here, “parallel” means that the distance between adjacent ridges is constant in a plan view. As illustrated in FIG. 13, when the ridge includes a curved portion, “parallel” means that the distance to the adjacent ridge along the normal line of the curved portion is constant. However, even if it is not completely parallel, a difference of 10% or less with respect to the distance to the adjacent ridge is regarded as constant, that is, parallel.

In FIG. 13, the serration region H is a region between an outer imaginary line S1 connecting ends 51T1 on the outer side in the tire radial direction of each ridge 51 and an inner imaginary line S2 connecting ends 51T2 on the inner side in the tire radial direction of each ridge 51. The distance between the outer imaginary line S1 and the inner imaginary line S2 is the length LH in the tire radial direction of the serration region H.

As illustrated in FIG. 14, when the lengths of the ridges are different, a region between the outer imaginary line S1 connecting the ends 51T1 on the outer side in the tire radial direction and the inner imaginary line S2 connecting the ends 51T2 on the inner side in the tire radial direction of each ridge 51 is the serration region H. As illustrated in FIG. 14, when the lengths of the ridges are not the same, the distance between the outermost position in the tire radial direction of the outer imaginary line S1 and the innermost position in the tire radial direction of the inner imaginary line S2, that is, the maximum width in the tire radial direction is the length LH in the tire radial direction of the serration region H.

### Ridge Shape

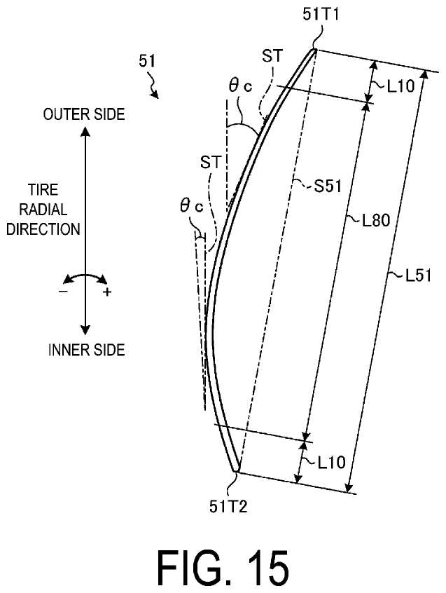

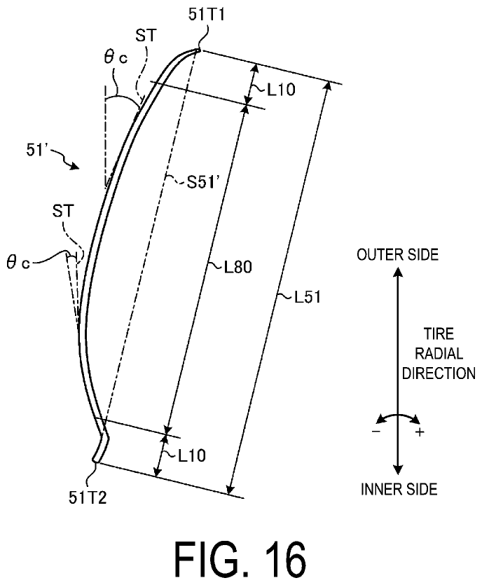

FIGS. 15 and 16 are diagrams illustrating an example of the shape of the ridge 51. FIGS. 15 and 16 are diagrams illustrating in an enlarged view of one ridge 51 in the serration region.

In FIG. 15, an angle of the ridge 51 in the extension direction with respect to the tire radial direction is defined as Oc. Here, regarding the angle θc, the clockwise angle is set to a plus (+) angle with respect to the direction toward the outer side in the tire radial direction, and the counterclockwise angle is set to a minus (−) angle with respect to the direction toward the outer side in the tire radial direction. As illustrated in FIG. 15, when the ridge 51 includes a curved portion, the length direction of a tangent line ST with respect to the curved portion is defined as the extension direction of the ridge 51.

The angle θc is preferably an angle within a range of ±20° with respect to the direction toward the outer side in the tire radial direction. By extending the extension direction of the ridge 51 at an angle close to the tire radial direction, the water adhering to the tire surface can be easily wetted and spread in the tire radial direction, and the deposits on the tire surface can be easily washed away. The angle θc is more preferably an angle within the range of ±10° with respect to the tire radial direction.

The angle θc does not have to be the angle within the above range over the entire length from the end 51T1 to the end 51T2 of the ridge 51. That is, with respect to an imaginary line S51 connecting the ends 51T1 and the ends 51T2 of the ridge 51 by a straight line, the angle θc may be any angle within the above range in a length L80 of 80% at the central portion of a total length L51 excluding a length L10 of 10% at both end portions.

In a ridge 51′ illustrated in FIG. 16, the curvature of the curved portion changes significantly in the vicinity of both ends. Regarding the ridge 51′ illustrated in FIG. 16, with respect to an imaginary line S51′ connecting the end 51T1 and the end 51T2 by a straight line, the angle θc may be any angle within the above range in the length L80 of 80% at the central portion of the length L51 excluding the length L10 of 10% at both end portions.

### Protrusion Portion

Returning to FIG. 1, in the tire meridian cross-sectional view, the protrusion portion B1 is located at an end portion on an outer side of the serration region H in the tire radial direction, and the protrusion portion B2 is located at an end portion on the inner side of the serration region H in the tire radial direction. The protrusion portion B1 extends in the tire circumferential direction at a position on the outer side of the serration region H in the tire radial direction. The protrusion portion B2 extends in the tire circumferential direction at a position on the inner side of the serration region H in the tire radial direction. The protrusion portion B1 and the protrusion portion B2 extend in the tire circumferential direction while connecting the ends of the ridge 51 described with reference to FIGS. 13 and 14. A recess and an air vent hole are provided in the mold to discharge air between the green tire and the mold during vulcanization molding of the tire. Therefore, the protrusion portion B1 and the protrusion portion B2 are formed at positions corresponding to the recesses of the mold. When the depth of the recesses of the mold is not uniform, the protrusion heights of the protrusion portion B1 and the protrusion portion B2 from the tire profile are not uniform and preferably change periodically.

Further, it is preferable that the protrusion heights of the protrusion portion B1 and the protrusion portion B2 from the tire profile change smoothly along the tire circumferential direction. The protrusion heights of the protrusion portion B1 and the protrusion portion B2 from the tire profile may be the largest in the portion C1 and a portion C2 in FIG. 2 and be the smallest in a portion D1 and a portion D2. Conversely, the protrusion height may be the smallest in the portion C1 and the portion C2 in FIG. 2 and be the largest in the portion D1 and the portion D2. In FIG. 2, assuming that the position of the portion C1 is the reference (0°) with respect to a rotation center axis J of the tire 1, the position of the portion D1 is the position of 90°, the position of the portion C2 is the position of 180°, and the position of the portion D2 is the position of 270°.

The protrusion heights of the protrusion portion B1 and the protrusion portion B2 from the tire profile preferably change in a range of 40% or more and 100% or less with respect to the maximum value. By periodically and smoothly changing the protrusion heights of the protrusion portion B1 and the protrusion portion B2 from the tire profile in the tire circumferential direction, air between the green tire and the mold can be efficiently discharged during vulcanization molding of the tire.

When the pneumatic tire 1 is mounted on a regular rim and inflated to the regular internal pressure, a protrusion height BH of the protrusion portion B1 and the protrusion portion B2 from the tire profile is 0.7 mm or less. By reducing the height of the protrusion portion extending in the tire circumferential direction, the water can smoothly flow out of the tire without blocking the water flow, and the cleaning performance is not reduced. It is more preferable that the protrusion heights of the protrusion portion B1 and the protrusion portion B2 from the tire profile are 0.2 mm or more and 0.5 mm or less.

### Examples

In the examples, tests for the contact angle, the cleaning performance, and the visibility performance, which are indicators of the hydrophilic property, were conducted on a plurality of types of pneumatic tires of different conditions (see Tables 1 to 5). In these tests, pneumatic tires having the size of 245/45R20 103W (20×8J) were assembled on a specified rim and inflated to a specified air pressure.

As for the contact angle, the contact angle of the obtained serration region sample with respect to water was measured by a measuring instrument. The measuring instrument used for the measurement is DM-901 available from Kyowa Interface Science Co., Ltd. The measurement was performed in accordance with JIS R3257. 2 (μl) of pure water was dropped to form water droplets, and the contact angle of the water droplets 30 seconds after the dropping was measured by the θ/2 method.

As for the cleaning performance, after mounting the pneumatic tire 1 on a 3000 cc rear-wheel drive vehicle and driving 40 km on a general road and 100 km on a highway under rainy weather conditions, the tires, completely dry, were washed for 30 seconds using a high-pressure washer (a water pressure of 100 bar and a flow rate of 300 L/h). The amount of dirt adhering to the tire side surface after washing was evaluated by sensory evaluation by three evaluators. The perfect score of 10 points was assigned to the appearance with black luster before the start of the test run. The smaller the degree of gray or white and the closer to black luster, the higher the score. Conversely, the larger the degree of gray or white, the lower the score. The evaluation was based on the average value of the total scores of the three evaluators. The score was set in 0.5 point increments, and the higher scores close to 10 points indicate better cleaning performance.

As for the visibility performance, a brand indicator was provided in the serration region, and how noticeable the brand indicator was was visually evaluated. The results are expressed as index values and evaluated, with the pneumatic tire of Conventional Example being assigned as 100. Larger values indicate superior visibility performance of the brand indicator.

The pneumatic tires of Examples 1 to 42 illustrated in Tables 1 to 5 include those in which the length Lb of one cycle of the ridge is 0.5 mm or more and 0.7 mm or less and those not, those in which the serration region H includes a plane portion and those not, those in which the ratio Lr/Lb of length Lr to length Lb of 1.2 or more and 2.0 or less and those not, those in which the ratio PH/RH of the height PH of the plane portion to the ridge height RH is 0.6 or more and 1.4 or less and those not, those in which the angle θp between the side wall of the plane portion and the base surface is 45° or more and 75° or less and those not, those in which the ratio RP/PH of the radius of curvature RP of the arc to the height PH of the plane portion is 0.5 or more and less than 1.0 and those not, those in which the opening width La is 0.15 mm or more and 0.35 mm or less and those not, those in which the ratio La/Lb is 0.3 or more and 0.6 or less and those not, those in which the length of the straight line of the flat portion of the base surface is 0.15 mm or more and those not, those in which the ratio RH/Lb of 0.11 or more and 0.3 or less and those not, those in which the ratio LH/SH of 0.2 or more and 0.4 or less and those not, those in which the ratio AH/SH of 0.3 or more 0.5 or less and those not, those in which the angle θr is 60° or more and 85° or less and those not, those in which the angle θc is within the range of ±20° with respect to the tire radial direction and those not, those in which the arithmetic mean roughness Ra of the rubber on the surface of the ridge is 0.1 μm or more and 5 μm or less and those not, those in which the protrusion height of the first protrusion portion and the second protrusion portion from the tire profile changes in the range of 40% or more and 100% or less with respect to the maximum value of the protrusion height and those not, and those in which the protrusion height from the tire profile of the first protrusion portion B1 and the second protrusion portion B2 is 0.7 mm or less and those not.

In the tire of Conventional Example in Table 1, the length Lb is 0.5 mm, no plane portion is provided in the serration region H, the ratio Lr/Lb is 1.2, the ratio PH/RH is 1.8, the angle θp is 90°, the opening width La is 0.12 mm, the ratio La/Lb is 0.24, the length of the straight line of the flat portion of the base surface is 0.03 mm, the ratio RH/Lb is 0.80, the ratio LH/SH is 0.16, the ratio AH/SH is 0.55, the angle θr is 50°, the angle θc is 45°, the arithmetic mean roughness Ra of rubber on the surface of the ridge is 10 μm, and the protrusion height of the first protrusion portion B1 and the second protrusion portion B2 from the tire profile is 0.8 mm.

In the tire of Comparative Example 1 in Table 1, the length Lb is 0.6 mm, the serration region H does not include a plane portion, the ratio PH/RH is 1.8, the angle θp is 90°, the opening width La is 0.12 mm, the ratio La/Lb is 0.20, the length of the straight line of the flat portion of the surface of the base surface is 0.03 mm, the ratio RH/Lb is 0.25, the ratio LH/SH is 0.16, the ratio AH/SH is 0.55, the angle θr is 50°, the angle θc is 45°, the arithmetic mean roughness Ra of the rubber on the surface of the ridge is 10 μm, and the protrusion height of the first protrusion portion B1 and the second protrusion portion B2 from the tire profile is 0.8 mm.

Referring to Tables 1 to 5, it can be seen that favorable results are obtained when the length Lb is 0.5 mm or more and 0.7 mm or less and the serration region H includes a plane portion, when the ratio Lr/Lb of the length Lr to the length Lb is 1.2 or more and 2.0 or less, when the ratio PH/RH is 0.6 or more and 1.4 or less, when the angle θp is 45° or more and 75° or less and those not, when the ratio RP/PH is 0.5 or more and less than 1.0, when the opening width La is 0.15 mm or more and 0.35 mm or less, when the ratio La/Lb is 0.3 or more and 0.6 or less, when the length of the straight line of the flat portion of the base surface is 0.15 mm or more, when the ratio RH/Lb is 0.11 or more and 0.3 or less, when the ratio LH/SH is 0.2 or more and 0.4 or less, when the ratio AH/SH is 0.3 or more and 0.5 or less, when the angle θr is 60° or more and 85° or less, when the angle θc is within the range of ±20° with respect to the tire radial direction, when the arithmetic mean roughness Ra of the rubber on the surface of the ridge is 0.1 μm or more and 5 μm or less, when the protrusion height of the first protrusion portion and the second protrusion portion from the tire profile changes in the range of 40% or more and 100% or less with respect to the maximum value of the protrusion height, and when the protrusion height of the first protrusion portion B1 and the second protrusion portion B2 from the tire profile is 0.7 mm or less.

TABLE 1-1

| | Conventional | Example | Comparative | Example |
|---|---|---|---|---|
| | Example | 1 | Example 1 | 2 |
| Length Lb | 0.5 | 0.6 | 0.6 | 0.52 |
| Presence of plane portion | No | Yes | No | Yes |
| Ratio Lr/Lb | 1.2 | 1.4 | 1.4 | 1.2 |
| Ratio PH/RH | 1.8 | 1 | 1.8 | 1 |
| Angle θp | 90 | 90 | 90 | 90 |
| Ratio RP/PH | — | — | — | — |
| Opening width La | 0.12 | 0.12 | 0.12 | 0.12 |
| Ratio La/Lb | 0.24 | 0.20 | 0.20 | 0.23 |
| Length of flat portion (mm) | 0.03 | 0.03 | 0.03 | 0.03 |
| Ratio RH/Lb | 0.80 | 0.25 | 0.25 | 0.29 |
| Ratio LH/SH | 0.16 | 0.16 | 0.16 | 0.16 |
| Ratio AH/SH | 0.55 | 0.55 | 0.55 | 0.55 |
| Angle θr (deg) | 50 | 50 | 50 | 50 |
| Angle θc (deg) | 45 | 45 | 45 | 45 |
| Ridge surface roughness Ra (μ/m) | 10 | 10 | 10 | 10 |
| Change in protrusion height of | — | — | — | — |
| protrusion portion (%) | | | | |
| Protrusion height of protrusion portion | 0.8 | 0.8 | 0.8 | 0.8 |
| Contact angle of serration region (deg) | 80 | 75 | 75 | 77 |
| Cleaning performance (score) | 5 | 6 | 5.5 | 5.5 |
| Visibility performance (score) | 100 | 102 | 98 | 101 |

TABLE 1-2

| | Example 3 | Example 4 | Example 5 | Example 6 | Example 7 |
|---|---|---|---|---|---|
| Length Lb | 0.7 | 0.5 | 0.6 | 0.6 | 0.6 |
| Presence of plane portion | Yes | Yes | Yes | Yes | Yes |
| Ratio Lr/Lb | 1.4 | 2.0 | 1.4 | 1.4 | 1.4 |
| Ratio PH/RH | 1 | 1 | 2 | 0.6 | 1.4 |
| Angle θp | 90 | 90 | 60 | 60 | 60 |
| Ratio RP/PH | — | — | — | — | — |
| Opening width La | 0.12 | 0.12 | 0.12 | 0.12 | 0.12 |
| Ratio La/Lb | 0.17 | 0.24 | 0.20 | 0.20 | 0.20 |
| Length of flat portion (mm) | 0.03 | 0.03 | 0.03 | 0.03 | 0.03 |
| Ratio RH/Lb | 0.21 | 0.30 | 0.25 | 0.25 | 0.25 |
| Ratio LH/SH | 0.16 | 0.16 | 0.16 | 0.16 | 0.16 |
| Ratio AH/SH | 0.55 | 0.55 | 0.55 | 0.55 | 0.55 |
| Angle θr (deg) | 50 | 50 | 50 | 50 | 50 |
| Angle θc (deg) | 45 | 45 | 45 | 45 | 45 |
| Ridge surface roughness Ra (μ/m) | 10 | 10 | 10 | 10 | 10 |
| Change in protrusion height of | — | — | — | — | — |
| protrusion portion (%) | | | | | |
| Protrusion height of protrusion portion | 0.8 | 0.8 | 0.8 | 0.8 | 0.8 |
| Contact angle of serration region (deg) | 74 | 72 | 74 | 74 | 74 |
| Cleaning performance (score) | 6 | 5.5 | 5.5 | 6.5 | 5.5 |
| Visibility performance (score) | 102 | 102 | 101 | 102 | 102 |

TABLE 2-1

| | Example 8 | Example 9 | Example 10 | Example 11 | Example 12 |
|---|---|---|---|---|---|
| Length Lb | 0.6 | 0.6 | 0.6 | 0.6 | 0.6 |
| Presence of plane portion | Yes | Yes | Yes | Yes | Yes |
| Ratio Lr/Lb | 1.4 | 1.4 | 1.4 | 1.4 | 1.4 |
| Ratio PH/RH | 1 | 1 | 1 | 1 | 1 |
| Angle θp | 45 | 75 | 60 | 60 | 60 |
| Ratio RP/PH | — | — | 0.1 | 0.5 | 0.3 |
| Opening width La | 0.12 | 0.12 | 0.12 | 0.12 | 0.12 |
| Ratio La/Lb | 0.20 | 0.2 | 0.2 | 0.2 | 0.2 |
| Length of flat portion (mm) | 0.03 | 0.03 | 0.03 | 0.03 | 0.03 |
| Ratio RH/Lb | 0.25 | 0.25 | 0.25 | 0.25 | 0.25 |
| Ratio LH/SH | 0.16 | 0.16 | 0.16 | 0.16 | 0.16 |
| Ratio AH/SH | 0.55 | 0.55 | 0.55 | 0.55 | 0.55 |
| Angle θr (deg) | 50 | 50 | 50 | 50 | 50 |
| Angle θc (deg) | 45 | 45 | 45 | 45 | 45 |
| Ridge surface roughness Ra (μ/m) | 10 | 10 | 10 | 10 | 10 |
| Change in protrusion height of | — | — | — | — | — |
| protrusion portion (%) | | | | | |
| Protrusion height of protrusion portion | 0.8 | 0.8 | 0.8 | 0.8 | 0.8 |
| Contact angle of serration region (deg) | 76 | 74 | 74 | 76 | 74 |
| Cleaning performance (score) | 6 | 6 | 6 | 6 | 6.5 |
| Visibility performance (score) | 102 | 102 | 102 | 102 | 103 |

TABLE 2-2

| | Example 13 | Example 14 | Example 15 | Example 16 |
|---|---|---|---|---|
| Length Lb | 0.6 | 0.6 | 0.6 | 0.6 |
| Presence of plane portion | Yes | Yes | Yes | Yes |
| Ratio Lr/Lb | 1.4 | 1.4 | 1.4 | 1.4 |
| Ratio PH/RH | 1 | 1 | 1 | 1 |
| Angle θp | 60 | 60 | 60 | 60 |
| Ratio RP/PH | 0.3 | 0.3 | 0.3 | 0.3 |
| Opening width La | 0.15 | 0.35 | 0.25 | 0.18 |
| Ratio La/Lb | 0.25 | 0.58 | 0.42 | 0.30 |
| Length of flat portion (mm) | 0.06 | 0.26 | 0.16 | 0.09 |
| Ratio RH/Lb | 0.25 | 0.25 | 0.25 | 0.25 |
| Ratio LH/SH | 0.16 | 0.16 | 0.16 | 0.16 |
| Ratio AH/SH | 0.55 | 0.55 | 0.55 | 0.55 |
| Angle θr (deg) | 50 | 50 | 50 | 50 |
| Angle θc (deg) | 45 | 45 | 45 | 45 |
| Ridge surface roughness Ra (μ/m) | 10 | 10 | 10 | 10 |
| Change in protrusion height | — | — | — | — |
| of protrusion portion (%) | | | | |
| Protrusion height of protrusion portion | 0.8 | 0.8 | 0.15 | 0.15 |
| Contact angle of serration region (deg) | 72 | 72 | 70 | 72 |
| Cleaning performance (score) | 6.5 | 6.5 | 7 | 7 |
| Visibility performance (score) | 103 | 103 | 104 | 104 |

TABLE 3-1

| | Example 17 | Example 18 | Example 19 | Example 20 | Example 21 |
|---|---|---|---|---|---|
| Length Lb | 0.6 | 0.6 | 0.6 | 0.6 | 0.6 |
| Presence of plane portion | Yes | Yes | Yes | Yes | Yes |
| Ratio Lr/Lb | 1.4 | 1.4 | 1.4 | 1.4 | 1.4 |
| Ratio PH/RH | 1 | 1 | 1 | 1 | 1 |
| Angle θp | 60 | 60 | 60 | 60 | 60 |
| Ratio RP/PH | 0.3 | 0.3 | 0.3 | 0.3 | 0.3 |
| Opening width La | 0.36 | 0.24 | 0.25 | 0.25 | 0.25 |
| Ratio La/Lb | 0.60 | 0.40 | 0.42 | 0.42 | 0.42 |
| Length of flat portion (mm) | 0.27 | 0.15 | 0.16 | 0.16 | 0.16 |
| Ratio RH/Lb | 0.25 | 0.25 | 0.11 | 0.3 | 0.25 |
| Ratio LH/SH | 0.16 | 0.16 | 0.16 | 0.16 | 0.2 |
| Ratio AH/SH | 0.55 | 0.55 | 0.55 | 0.55 | 0.55 |
| Angle θr (deg) | 50 | 50 | 50 | 50 | 50 |
| Angle θc (deg) | 45 | 45 | 45 | 45 | 45 |
| Ridge surface roughness Ra (μ/m) | 10 | 10 | 10 | 10 | 10 |
| Change in protrusion height of | — | — | — | — | — |
| protrusion portion (%) | | | | | |
| Protrusion height of protrusion portion | 0.15 | 0.15 | 0.15 | 0.15 | 0.15 |
| Contact angle of serration region (deg) | 72 | 73 | 75 | 73 | 73 |
| Cleaning performance (score) | 7 | 7 | 7 | 6.5 | 6.5 |
| Visibility performance (score) | 104 | 104 | 103 | 104 | 104 |

TABLE 3-2

| | Example 22 | Example 23 | Example 24 | Example 25 |
|---|---|---|---|---|
| Length Lb | 0.6 | 0.6 | 0.6 | 0.6 |
| Presence of plane portion | Yes | Yes | Yes | Yes |
| Ratio Lr/Lb | 1.4 | 1.4 | 1.4 | 1.4 |
| Ratio PH/RH | 1 | 1 | 1 | 1 |
| Angle θp | 60 | 60 | 60 | 60 |
| Ratio RP/PH | 0.3 | 0.3 | 0.3 | 0.3 |
| Opening width La | 0.25 | 0.25 | 0.25 | 0.25 |
| Ratio La/Lb | 0.42 | 0.42 | 0.42 | 0.42 |
| Length of flat portion (mm) | 0.16 | 0.16 | 0.16 | 0.16 |
| Ratio RH/Lb | 0.25 | 0.25 | 0.25 | 0.25 |
| Ratio LH/SH | 0.4 | 0.3 | 0.3 | 0.3 |
| Ratio AH/SH | 0.55 | 0.2 | 0.4 | 0.3 |
| Angle θr (deg) | 50 | 50 | 50 | 50 |
| Angle θc (deg) | 45 | 45 | 45 | 45 |
| Ridge surface roughness Ra (μ/m) | 10 | 10 | 10 | 10 |
| Change in protrusion height | — | — | — | — |
| of protrusion portion (%) | | | | |
| Protrusion height of protrusion portion | 0.15 | 0.15 | 0.15 | 0.15 |
| Contact angle of serration region (deg) | 73 | 73 | 73 | 71 |
| Cleaning performance (score) | 7 | 6.5 | 7 | 7.5 |
| Visibility performance (score) | 103 | 104 | 103 | 105 |

TABLE 4-1

| | Example 26 | Example 27 | Example 28 | Example 29 | Example 30 |
|---|---|---|---|---|---|
| Length Lb | 0.6 | 0.6 | 0.6 | 0.6 | 0.6 |
| Presence of plane portion | Yes | Yes | Yes | Yes | Yes |
| Ratio Lr/Lb | 1.4 | 1.4 | 1.4 | 1.4 | 1.4 |
| Ratio PH/RH | 1 | 1 | 1 | 1 | 1 |
| Angle θp | 60 | 60 | 60 | 60 | 60 |
| Ratio RP/PH | 0.3 | 0.3 | 0.3 | 0.3 | 0.3 |
| Opening width La | 0.25 | 0.25 | 0.25 | 0.25 | 0.25 |
| Ratio La/Lb | 0.42 | 0.42 | 0.42 | 0.42 | 0.42 |
| Length of flat portion (mm) | 0.16 | 0.16 | 0.16 | 0.16 | 0.16 |
| Ratio RH/Lb | 0.25 | 0.25 | 0.25 | 0.25 | 0.25 |
| Ratio LH/SH | 0.3 | 0.3 | 0.3 | 0.3 | 0.3 |
| Ratio AH/SH | 0.3 | 0.3 | 0.3 | 0.3 | 0.3 |
| Angle θr (deg) | 80 | 85 | 70 | 70 | 70 |
| Angle θc (deg) | 45 | 45 | 45 | 45 | −45 |
| Ridge surface roughness Ra (μ/m) | 10 | 10 | 10 | 10 | 10 |
| Change in protrusion height of | — | — | — | 60 | 60 |
| protrusion portion (%) | | | | | |
| Protrusion height of | 0.15 | 0.15 | 0.15 | 0.15 | 0.15 |
| protrusion portion | | | | | |
| Contact angle of | 69 | 71 | 69 | 69 | 69 |
| Serration region (deg) | | | | | |
| Cleaning performance (score) | 7.5 | 7.5 | 7.5 | 8 | 8 |
| Visibility performance (score) | 106 | 105 | 106 | 108 | 108 |

TABLE 4-2

| | Example 31 | Example 32 | Example 33 | Example 34 |
|---|---|---|---|---|
| Length Lb | 0.6 | 0.6 | 0.6 | 0.6 |
| Presence of plane portion | Yes | Yes | Yes | Yes |
| Ratio Lr/Lb | 1.4 | 1.4 | 1.4 | 1.4 |
| Ratio PH/RH | 1 | 1 | 1 | 1 |
| Angle θp | 60 | 60 | 60 | 60 |
| Ratio RP/PH | 0.3 | 0.3 | 0.3 | 0.3 |
| Opening width La | 0.25 | 0.25 | 0.25 | 0.25 |
| Ratio La/Lb | 0.42 | 0.42 | 0.42 | 0.42 |
| Length of flat portion (mm) | 0.16 | 0.16 | 0.16 | 0.16 |
| Ratio RH/Lb | 0.25 | 0.25 | 0.25 | 0.25 |
| Ratio LH/SH | 0.3 | 0.3 | 0.3 | 0.3 |
| Ratio AH/SH | 0.3 | 0.3 | 0.3 | 0.3 |
| Angle θr (deg) | 70 | 70 | 70 | 70 |
| Angle θc (deg) | 20 | 10 | −20 | −10 |
| Ridge surface roughness Ra (μ/m) | 10 | 10 | 10 | 10 |
| Change in protrusion height | 60 | 60 | 60 | 60 |
| of protrusion portion (%) | | | | |
| Protrusion height of protrusion portion | 0.15 | 0.15 | 0.15 | 0.15 |
| Contact angle of Serration | 69 | 69 | 69 | 69 |
| region (deg) | | | | |
| Cleaning performance (score) | 8.5 | 8.5 | 8.5 | 8.5 |
| Visibility performance (score) | 109 | 110 | 109 | 110 |

TABLE 5-1

| | Example 35 | Example 36 | Example 37 | Example 38 |
|---|---|---|---|---|
| Length Lb | 0.6 | 0.6 | 0.6 | 0.6 |
| Presence of plane portion | Yes | Yes | Yes | Yes |
| Ratio Lr/Lb | 1.4 | 1.4 | 1.4 | 1.4 |
| Ratio PH/RH | 1 | 1 | 1 | 1 |
| Angle θp | 60 | 60 | 60 | 60 |
| Ratio RP/PH | 0.3 | 0.3 | 0.3 | 0.3 |
| Opening width La | 0.25 | 0.25 | 0.25 | 0.25 |
| Ratio La/Lb | 0.42 | 0.42 | 0.42 | 0.42 |
| Length of flat portion (mm) | 0.16 | 0.16 | 0.16 | 0.16 |
| Ratio RH/Lb | 0.25 | 0.25 | 0.25 | 0.25 |
| Ratio LH/SH | 0.3 | 0.3 | 0.3 | 0.3 |
| Ratio AH/SH | 0.3 | 0.3 | 0.3 | 0.3 |
| Angle θr (deg) | 70 | 70 | 70 | 70 |
| Angle θc (deg) | 0 | 0 | 0 | 0 |
| Ridge surface roughness Ra (μ/m) | 10 | 0.1 | 5 | 3 |
| Change in protrusion height | 60 | 60 | 60 | 40 |
| of protrusion portion (%) | | | | |
| Protrusion height of protrusion portion | 0.15 | 0.15 | 0.15 | 0.15 |
| Contact angle of serration region (deg) | 69 | 68 | 65 | 65 |
| Cleaning performance (score) | 8.5 | 8.5 | 8.5 | 8.5 |
| Visibility performance (score) | 111 | 111 | 113 | 113 |

TABLE 5-2

| | Example 39 | Example 40 | Example 41 | Example 42 |
|---|---|---|---|---|
| Length Lb | 0.6 | 0.6 | 0.6 | 0.6 |
| Presence of plane portion | Yes | Yes | Yes | Yes |
| Ratio Lr/Lb | 1.4 | 1.4 | 1.4 | 1.4 |
| Ratio PH/RH | 1 | 1 | 1 | 1 |
| Angle θp | 60 | 60 | 60 | 60 |
| Ratio RP/PH | 0.3 | 0.3 | 0.3 | 0.3 |
| Opening width La | 0.25 | 0.25 | 0.25 | 0.25 |
| Ratio La/Lb | 0.42 | 0.42 | 0.42 | 0.42 |
| Length of flat portion (mm) | 0.16 | 0.16 | 0.16 | 0.16 |
| Ratio RH/Lb | 0.25 | 0.25 | 0.25 | 0.25 |
| Ratio LH/SH | 0.3 | 0.3 | 0.3 | 0.3 |
| Ratio AH/SH | 0.3 | 0.3 | 0.3 | 0.3 |
| Angle θr (deg) | 70 | 70 | 70 | 70 |
| Angle θc (deg) | 0 | 0 | 0 | 0 |
| Ridge surface roughness Ra (μ/m) | 3 | 3 | 3 | 1 |
| Change in protrusion height | 80 | 100 | 60 | 60 |
| of protrusion portion (%) | | | | |
| Protrusion height of protrusion portion | 0.15 | 0.15 | 0.6 | 0.15 |
| Contact angle of serration region (deg) | 65 | 65 | 65 | 65 |
| Cleaning performance (score) | 9 | 8.5 | 8 | 9 |
| Visibility performance (score) | 116 | 115 | 110 | 115 |

1-17. (canceled)

18. A pneumatic tire comprising: a tread portion; a sidewall portion; and a bead portion,
a serration region being provided in a predetermined region of the sidewall portion,
the serration region being formed by arranging a plurality of ridges,
the plurality of ridges protruding from a base surface in parallel to each other and periodically,
a length Lb of one cycle of the plurality of ridges along the base surface being 0.5 mm or more and 0.7 mm or less, and
the pneumatic tire comprising a plane portion surrounded by the serration region.

19. The pneumatic tire according to claim 18, wherein, when a length of the one cycle of the plurality of ridges along the base surface is defined as the length Lb, and a length along a contour of the ridge per the one cycle in a cross-sectional view along a direction orthogonal to an extension direction of the plurality of ridges is defined as a length Lr, a ratio Lr/Lb of the length Lr to the length Lb is 1.2 or more and 2.0 or less.

20. The pneumatic tire according to claim 18, wherein a ratio PH/RH of a height PH of the plane portion from the base surface to a height RH of each of the plurality of ridges from the base surface is 0.6 or more and 1.4 or less.

21. The pneumatic tire according to claim 18, wherein an angle θp between a side wall of the plane portion and the base surface is 45° or more and 75° or less, in a cross-sectional view along a tire radial direction of a connection portion between each of the plurality of ridges and the plane portion.

22. The pneumatic tire according to claim 18, wherein in a cross-sectional view along a tire radial direction of a connection portion between each of the plurality of ridges and the plane portion, in a portion where a contour line of a top surface of the plane portion and a contour line of a side wall of the plane portion intersect each other, the contour lines are connected by an arc that is single, and a ratio RP/PH of a radius of curvature RP of the arc to a height PH of the plane portion from the base surface is 0.5 or more and less than 1.0.

23. The pneumatic tire according to claim 18, wherein an opening width La between the ridges that are adjacent is 0.15 mm or more and 0.35 mm or less, in a cross-sectional view along a direction orthogonal to an extension direction of the ridge.

24. The pneumatic tire according to claim 23, wherein a ratio La/Lb of the opening width La to the length Lb is 0.3 or more and 0.6 or less.

25. The pneumatic tire according to claim 18, wherein
the base surface comprises a flat portion having no unevenness,
the flat portion is a straight line in a cross-sectional view along a direction orthogonal to an extension direction of the ridge, and
a length of the straight line is 0.15 mm or more.

26. The pneumatic tire according to claim 18, wherein a ratio RH/Lb, to the length Lb, of a height RH from the base surface to a maximum projection position of the ridge is 0.11 or more and 0.3 or less.

27. The pneumatic tire according to claim 18, wherein in a tire meridian cross-section, a ratio LH/SH, to a tire cross-sectional height SH, of a length LH in a tire radial direction of a range in the tire radial direction of the serration region is 0.2 or more and 0.4 or less.

28. The pneumatic tire according to claim 18, wherein in a tire meridian cross-section, when a height along a tire radial direction from a measurement point of a rim diameter of a rim on which the pneumatic tire is mounted to a position on an inner side of the serration region in the tire radial direction is defined as AH, a ratio AH/SH of the height AH to a tire cross-sectional height SH is 0.3 or more and 0.5 or less.

29. The pneumatic tire according to claim 18, wherein an angle θr between a flat portion of the base surface having no unevenness and a wall surface of the ridge is 60° or more and 85° or less.

30. The pneumatic tire according to claim 18, wherein an angle θc in an extension direction of the ridge with respect to a tire radial direction is within a range of ±20° with respect to the tire radial direction.

31. The pneumatic tire according to claim 18, wherein an arithmetic mean roughness Ra of rubber on a surface of the ridge is 0.1 μm or more and 5 μm or less.

32. The pneumatic tire according to claim 18, further comprising a first protrusion portion extending in a tire circumferential direction at a position on an outer side of the serration region in a tire radial direction, and a second protrusion portion extending in the tire circumferential direction at a position on an inner side of the serration region in the tire radial direction.

33. The pneumatic tire according to claim 32, wherein
a protrusion height of the first protrusion portion and the second protrusion portion from a tire profile smoothly changes along the tire circumferential direction, and
the protrusion height changes in a range of 40% or more and 100% or less with respect to a maximum value of the protrusion height.

34. The pneumatic tire according to claim 32, wherein a protrusion height of the first protrusion portion and the second protrusion portion from a tire profile is 0.7 mm or less.
